(19) United States
(12) Patent Application Publication
(10) Pub. No.: US 2026/0302341 A1
(43) Pub. Date: Oct. 1, 2026

(54) Plasma-assisted rapid processing of high-throughput, solution deposited solid-state ionic conductors

(71) Applicant: The Board of Trustees of the Leland Stanford Junior University Office of the General Counsel, Bldg, Stanford, CA (US)

(72) Inventors: Reinhold H. Dauskardt, Menlo Park, CA (US); Thomas W. Colburn, Redwood City, CA (US); Gabriel Badillo Crane, Stanford, CA (US); Sarah E. Holmes, San Francisco, CA (US); Yi Cui, Stanford, CA (US)

(21) Appl. No.: 19/480,746

(22) PCT Filed: May 3, 2024
(86) PCT No.: PCT/US2024/027822

§ 371 Date: Oct. 31, 2025

Related U.S. Application Data
(60) Provisional application No. 63/463,809, filed on May 3, 2023.

(51) Int. Cl. H01M 10/0562; H01M 10/0525

(52) U.S. Cl. CPC H01M 10/0562; H01M 10/0525; H01M 2300/0071

(57) ABSTRACT

Improved fabrication of solid state ionic conductors is performed with rapid plasma processing. This approach provides much faster throughput than conventional methods that require long sintering times in a fully controlled atmosphere. In one example, an amorphous solid state electrolyte layer for a Li battery is made having a room temperature ionic conductivity above 10−6 S/cm. In some embodiments, a gas shroud is used to provide local control of humidity and/or oxygen concentration.

### FIELD OF THE INVENTION

This invention relates to fabrication of ionic conductors.

### BACKGROUND

Scalable manufacturing is a critical hurdle for the deployment of batteries containing solid-state electrolytes (SSEs). Thin SSEs (<10 μm) are typically deposited using slow and energy-intensive techniques such as ALD (atomic layer deposition) and PLD (pulsed laser deposition) in vacuum or inert gas atmospheres and then cured into the correct chemical phase in argon ovens at high temperatures >400°C. These conventional fabrication processes are generally low-throughput and cannot take place on an in-line or roll-to-roll manufacturing line. Accordingly, it would be an advance in the art to provide improved fabrication of solid-state electrolytes, and more generally, improved fabrication of ionic conductors.

### SUMMARY

With our approach, SSEs can be deposited via a rapid solution deposition technique (i.e., blade coating, spray coating, dip casting, roll-to-roll printing, etc.) directly onto the anode current collector or onto the cathode. Then, open-air plasma processing can enable rapid SSE fabrication at lower temperatures owing to the plasma's combination of UV photons, heat, and reactive ions. This deposition technique can be incorporated directly into manufacturing lines and enables high throughput deposition and film formation. This approach would provide significant reductions in cost, energy input, and manufacturing time relative to the methods currently in use.

An example of our approach is a method for developing thin film (10 nm-10 μm) solid-state electrolytes for alkali metal (i.e., Li metal anode) and alkali-ion batteries comprising scalable, high-throughput solution deposition of solid electrolyte precursor followed by rapid plasma processing. The plasma can form the SSEs using a combination of heat, reactive ionic and radical species, and UV photons present in the afterglow of a plasma discharge for low-temperature, rapid processing of the SSE precursors into the desired chemical phase. This plasma processing results in the conversion of a solution of dissolved metal nitrates and alkoxides into the desirable metal oxide phase in a single step. The solution begins with a mixture of metal alkoxides (i.e., methoxides, ethoxides, propoxides, butoxides of Li, Na, K, Rb, La, Zr, Ti, etc.), metal nitrates (i.e., nitrates and oxynitrates of Li, Na, La, Zr, etc.) , and a polar solvent (i.e., ethanol, 2-methoxyethanol, etc.).

It is a surprising finding that such high-quality lithium-based films can be manufactured so rapidly and at such scale as we have demonstrated. Lithium is quite reactive with water vapor and carbon dioxide in air, forming lithium hydroxide and then lithium carbonate, which reduces the ionic conductivity of the film and worsens the morphology. Thus, LLZO thin films are typically fabricated in small batches and sintered for long periods of time (>30 minutes) and in inert atmospheres (argon, nitrogen, or in vacuum). We demonstrate excellent film quality and performance without the use of an inert atmosphere and at lateral speeds exceeding 3 cm/minute, with the potential for significantly faster speeds.

For use as SSE in batteries, integration of an alkali element (i.e., Li, Na, K, etc.) is important for electrochemical applications. The use of a rapid plasma in an atmosphere that is controlled for humidity and oxygen content allows for the generation of alkali metal-containing thin films for use batteries without the need for inert atmosphere (i.e., under argon) largely due to the swift nature (on the order of seconds) required to convert the precursor solution to the metal oxide. The increased energy transfer effectuated by a plasma approach significantly improves film formation speed relative to a traditional vacuum oven-based approach. This plasma processing step is not merely a heating step but involves the chemical change of the precursors to the oxide and could also be used for the formation of metal oxide crystallites. Generally, concerns of the formation of unwanted secondary phases (i.e., carbonates, hydroxides, nitrides, etc. of the alkali metal) would be present for processing battery materials like LLZO, LLTO, etc., in air; however, the plasma approach is able to ameliorate those concerns. This innovation enables both isolation of the desirable oxide without the additional issue arising from air's composition containing nitrogen, oxygen, carbon dioxide, and water vapor. These atmospheric gases would generally react with the surface of the alkali-metal containing oxide, but the preferred embodiment of this method uses a local atmospheric-pressure shroud around the plasma discharge which is able to passivate the surface with the use of a gas to protect the SSE during processing, along with a controlled humidity to prevent reactions post-plasma processing. Moreover, the resulting films show excellent electrochemical (as Li-ion conductors) and mechanical quality with increased manufacturing speed and efficiency.

Significant advantages are provided. Most SSBs are produced with non-scalable and low-throughput methods including spin coating, vacuum sputtering, or tube furnaces. While these processes are effective at forming films at lab scale, these methods are not practical for manufacturing. For deposition, spin coating creates films on the centimeter scale, while vacuum sputtering is cost prohibitive. For annealing, tube furnaces require a long ramp-up and ramp-down time to heat and can only provide fully equilibrated thermal treatment. The battery marketplace demands higher throughput techniques for SSBs to compete with liquid-based lithium-ion batteries.

The solid-state electrolytes created via methods described herein are ideally suited to ameliorate costly and low-throughput challenges of current SSB production. The described plasma utilizes a plasma formed at ambient pressure and nominally atmospheric compositions or controlled atmospheric conditions to yield a nitrogen plasma (or a plasma with tunable gas inputs, e.g. argon, forming, etc.) which is delivered by a nozzle to the substrate and is capable of both rapid high temperature thermal treatments as well as delivering doses of high energy photons and reactive ions to rapidly cure sprayed films. Here, plasma processing includes the use of controlled humidity atmospheres (i.e., ultra-dry air) or pure inert environment for operation of the plasma.

A first application of this work enables the commercialization of dense, high-quality solid-state electrolytes (SSEs) for solid-state battery technologies, which are currently limited to laboratory-scale research due to the lack of manufacturing efforts. This manufacturing solution targets lowering the costs of large-scale manufacturing of solid-state batteries, including lithium-ion and lithium metal batteries. A solid-state battery would solve concerns of toxic gas emissions and fires in liquid electrolyte systems, while providing gains in both volumetric and gravimetric energy density. Thus, this approach would be relevant to the manufacturing of batteries for any device (such as phones, electric vehicles, and grid storage) requiring safe, lightweight, and energy-dense batteries.

A second application of this work is research of new SSEs. The plasma can be used as a tool in the rapid optimization of any new SSE owing to its highly tunable temperature and environment for thin film processing. The high speed plasma processing can allow SSEs to have unique chemical compositions, including high lithium or dopant concentrations that are not accessible using oven sintering that forces equilibrium to be reached over the long processing times. As such, battery research and manufacturing companies can use this work to rapidly discover new SSEs, optimize the manufacturing process, and improve their research speed.

### BRIEF DESCRIPTION OF THE DRAWINGS

FIG. 1 shows an exemplary fabrication process according to an embodiment of the invention.

FIG. 2 shows optical spectroscopy of the plasma in various operating conditions.

FIGS. 3A-C schematically show effects of several processing steps on LLZO fabrication.

FIG. 4 is a scanning electron microscope image of a fabricated LLZO layer.

FIG. 5 is an atomic force microscope image of a fabricated LLZO layer.

FIGS. 6A-B show cross sections comparing sintered LLZO to plasma-cured LLZO.

FIG. 7 shows X-ray diffraction results from a plasma-cured LLZO layer.

FIGS. 8A-B shows XPS results from a plasma-cured LLZO layer (A) compared with argon oven sintered samples (B).

FIGS. 9A-B show electrochemical impedance spectroscopy results from a plasma-cured LLZO layer.

FIG. 10 is an Arrhenius plot of ionic conductivity of a plasma-cured LLZO layer.

FIG. 11 shows measured electronic conductivity of a plasma-cured LLZO layer.

### DETAILED DESCRIPTION

Section A describes general principles relating to embodiments of the invention. Section B relates to an example of lithium lanthanum zirconium oxide (LLZO) solid-state electrolytes, both fabrication details and characterization results.

### A) General Principles

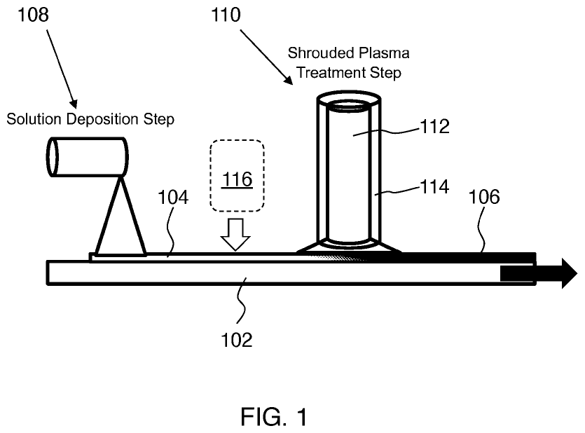

FIG. 1 schematically shows an exemplary solution deposition method and plasma cure with shroud to form ionic conductors. Here a substrate 102 moves to the right as shown by the arrow underneath a solution deposition station 108 and a plasma treatment station 110. The result of solution deposition is deposited precursors 104. Plasma treatment of the deposited precursors 104 forms the solid-state ionic conductor layer 106. Preferably, plasma treatment station 110 includes a shroud 114 around plasma source 112 to provide local control of humidity and/or oxygen concentration. Optionally, a drying station 116 can be used to dry the deposited precursors after solution deposition and before plasma treatment.

Accordingly, an exemplary embodiment of the invention is a method of forming a solid-state ionic conductor layer. The method includes:
solution depositing one or more precursors on a substrate to provide deposited precursors, where the deposited precursors include at least one metal species; and
plasma treating the deposited precursors by exposing the deposited precursors to a plasma discharge to form the solid-state ionic conductor layer. One or more chemical reactions including oxidation of the metal species are driven by the plasma discharge to form the solid-state ionic conductor layer from the deposited precursors.

Here an open-air discharge refers to a plasma discharge into an enclosure that is at ambient pressure and provides total control of gas composition. Thus a plasma discharge into an ambient environment controlled locally by a gas shroud is an example of an open-air discharge. The important point here is to provide control of gas composition compatible with high throughput processing shown on FIG. 1. The plasma discharge can also be into a controlled environment with an inert gas as the environment. Both are viable manufacturing options for this method.

The thickness of the solid-state ionic conductor layer can be in a range from 10 nm to 200 μm. Suitable metal species include: Li, Na, K, Al, Mg, Rb, La, Zr, and Ti. A formation speed of the solid-state ionic conductor layer is preferably in a range from 0.1 mm/minute to 100 m/minute.

The plasma discharge can include species such as: N, Ar, O, H, and radicals or ions thereof. The temperature of the plasma discharge is preferably between 100° C. and 900° C.

Optionally, the method can include drying the deposited precursors after the solution depositing and before the plasma treating.

The plasma discharge in some preferred embodiments is into a gas shroud providing at least local control of relative humidity. The gas shroud can provide a relative humidity of 5% or less and a controlled oxygen concentration between 0 and 25%. The gas shroud can also perform a condensation and densification function for the deposited precursors at a temperature in a range from 50° C. to 300° C.

Practice of the invention does not depend critically on how the precursors are deposited. Suitable methods include, but are not limited to: spray deposition, blade deposition and slot-die casting.

The solid-state ionic conductor layer can be an electrolyte layer for a solid-state battery. Preferably, the ionic conductivity of the solid-state ionic conductor layer is 10⁻⁷ S/cm or more.

### B) Detailed Example and Characterization Results

### B1) Fabrication

An exemplary preferred realization of this process is outlined for the formation of lithium lanthanum zirconium oxide (Li₇₋₁₄La₃Zr₂Oₓ) in two steps: solution phase deposition and plasma processing.

1) Deposition: The precursor solution is fed through an ultrasonic spray nozzle typically operating at a power between 1 and 5 W. The spray nozzle deposits a uniform thin film of the solution onto the substrate to the desired thickness. The spray nozzle deposits solution at a controlled rate typically between 100 uL and 1 mL per minute and at a height of less than 10 cm. The shape of the spray nozzle can be varied and is not critical for practicing the invention—this can include but is not limited to atomizing nozzles with and without flat air deflectors. Alternately, this solution may be fabricated by other solution deposition method (i.e., blade-coated or slot die cast). This layer can be subsequently dried of excess solvent or plasma cured directly following deposition. The method of drying is not critical for practicing the invention—this can include but is not limited to hot plate heating pre-anneal or in conjunction with the plasma processing step. The final SSE layer thickness can vary in thickness from tens of nanometers to tens of microns in thickness.

2) Plasma processing: A plasma comprising ionized and/or radical species of nitrogen, argon, oxygen, and/or hydrogen is then utilized at temperatures ranging from 100-900 C to cure and rapidly processing the thin film in a controlled humidity (<10% relative humidity), open-air environment or fully inert environment. The open-air plasma is discharged into a local shroud environment where an inert gas is locally introduced at atmospheric pressure. Here the local plasma environment can include oxygen, nitrogen, forming gas, argon, or other gases in tunable ratios, which may vary substantially from the environment directly outside the shroud. The fully inert environment can consist of any combination of helium, argon, nitrogen, xenon, krypton, or other gases in tunable ratios. This environment would typically have the normal atmospheric composition with the regulation of only humidity to <10% RH. The plasma-shroud system enables film processing at speeds varying from 1 mm/min to 10 m/min. The shroud is typically at a height of <1 mm up to 5 cm above the sample, while the spacing between the tip of the plasma nozzle and the bottom of the shroud can vary from 0 mm up to 10 cm. This shroud system is not under any gas-tight seals and, instead, allows for the shroud gas to continually flow over the sample surface and then diffuse into the local air environment. We have found the use of the shroud to be preferred in particular for the mitigation of alkali carbonate defect species on the sample surface.

The shroud system further enables fine temperature control within the shroud, including the ability to pre-dry (e.g. removal of solvent) the sample at a controllable temperature typically ranging from 50-200 C, as well as individually control the relative energy supplied by heat and plasma to the film with such methods including but not limited to tuning the shroud-nozzle spacing as well as modifying the plasma duty cycle.

This process is not exclusive to LLZO and is expected to be applicable to other mixed oxide, phosphorous, nitrogen, and sulfur-containing SSE materials that can be made using a solution-based process such as:
1. Li_{3.6}PO_{3.4}N_{0.6}
2. Li_{3.3}La_{0.56}TiO₃ and LiLaTiO₄ (LLTO)
3. LiTi₂(PO₄)₃ and Li_{1.5}Al_{0.5}Ti_{1.5}(PO₄)₃
4. Li₁₄Zn(GeO₄)₄
5. Li₁₊ₓAlₓGe₂₋ₓ(PO₄)₃

This process is not unique to lithium-containing SSEs and can be used with other alkaline metal SSEs (sodium- or potassium-based).

### B2) Characterization

The formation of the films has been characterized using SEM, XRD, XPS, EIS, profilometry, and optical microscopy. This process is demonstrated using the SSE lithium lanthanum zirconium oxide (LLZO). LLZO is a mixed-oxide material that is typically fabricated using vacuum-based deposition, sputtering, or in bulk using sol-gel synthesis in inert gas environments or in vacuum due to lithium's tendency to react with water vapor in air. In our process, our open-air plasma includes the use of controlled humidity and localized shroud atmosphere to minimize this process.

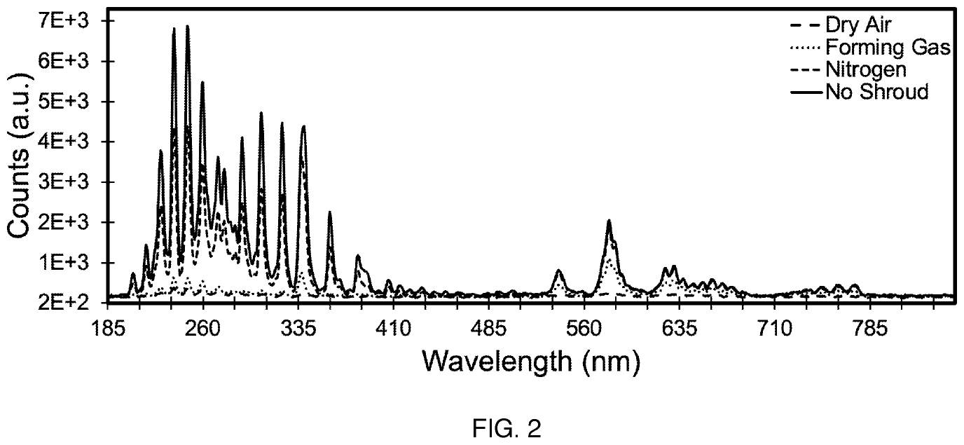

FIG. 2 shows optical emission spectroscopy of the plasma with various shroud gas environments.

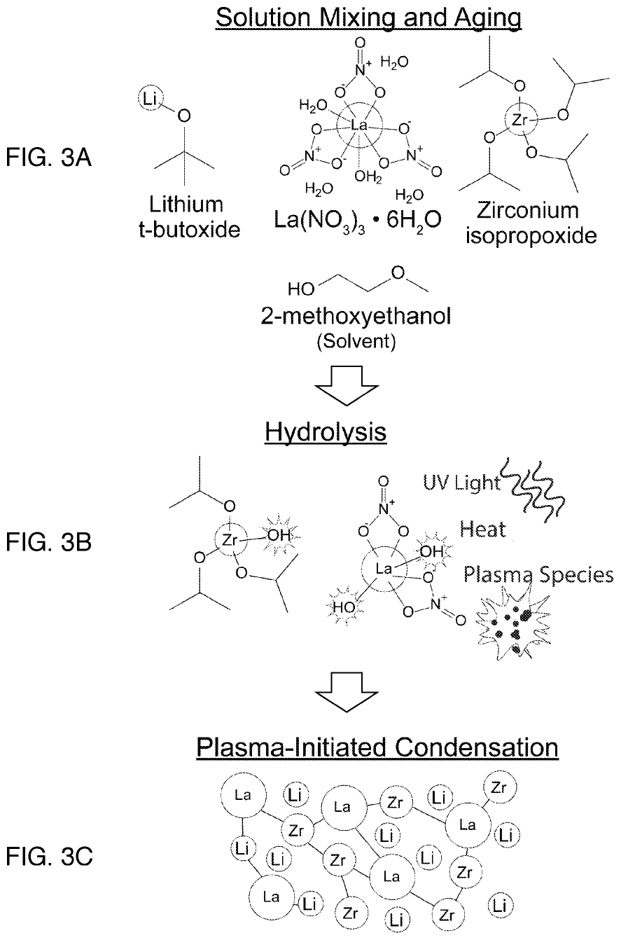

FIGS. 3A-C schematically show the sol-gel electrolyte layer formation process for the preferred embodiment of amorphous LLZO using plasma. Here FIG. 3A shows the result of depositing the precursors, FIG. 3B shows the effect of hydrolysis during the plasma treatment, and FIG. 3C shows the result of condensation during the plasma treatment.

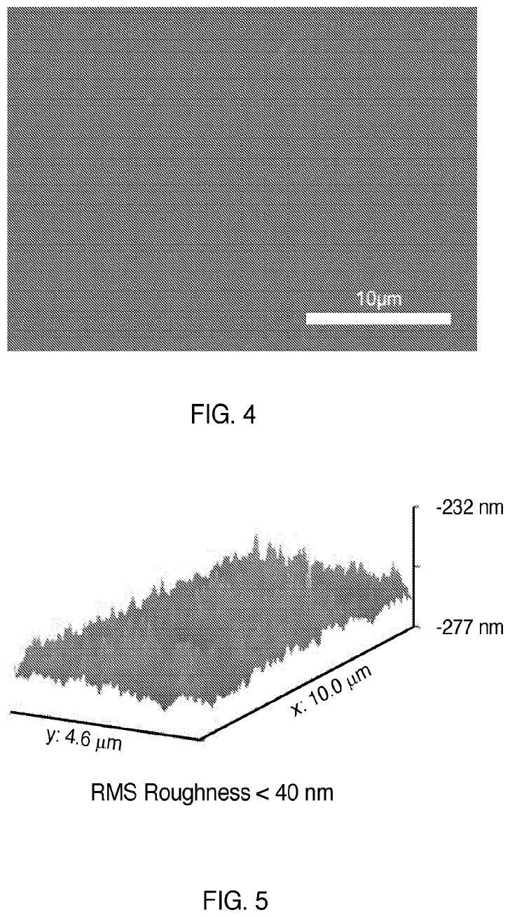

FIG. 4 is a top-down scanning electron microscopy image of the fabricated LLZO electrolyte layer, showing good uniformity.

FIG. 5 is an atomic force microscopy image of the LLZO layer showing less than 40 nm root mean square roughness.

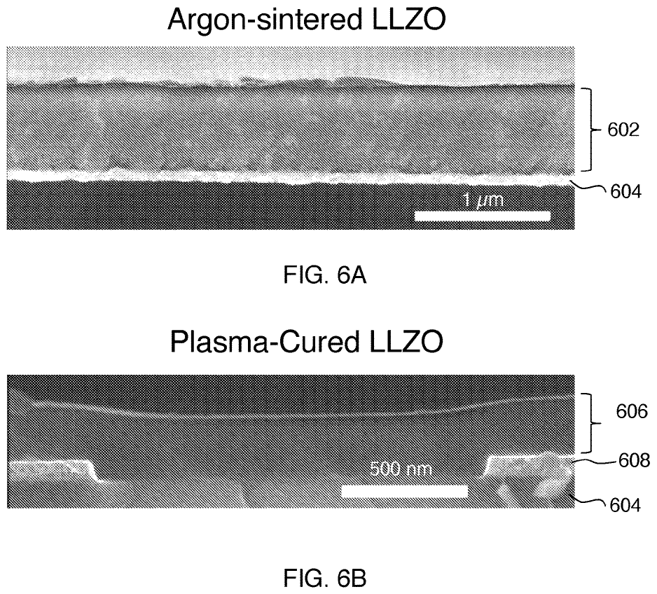

FIGS. 6A-B show cross sectional scanning electron microscopy images comparing electrolytes formed by sintering under argon (FIG. 6A) compared with plasma-cured layers (FIG. 6B). Here 602 is sintered LLZO, 604 is alumina, 606 is plasma-cured LLZO, and 608 is a platinum electrode.

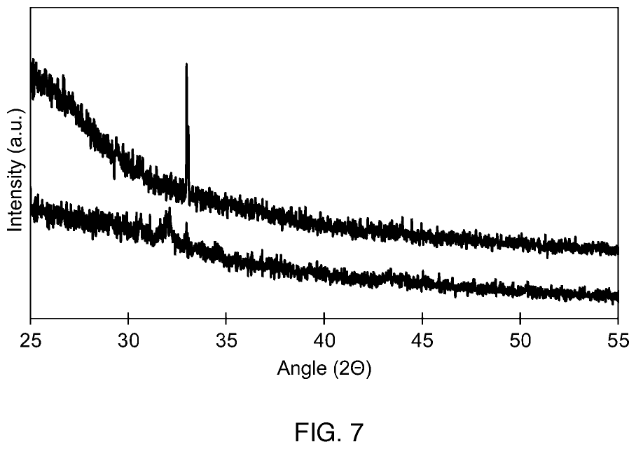

FIG. 7 shows X-ray diffraction results of a plasma-cured LLZO layers, showing that it is amorphous.

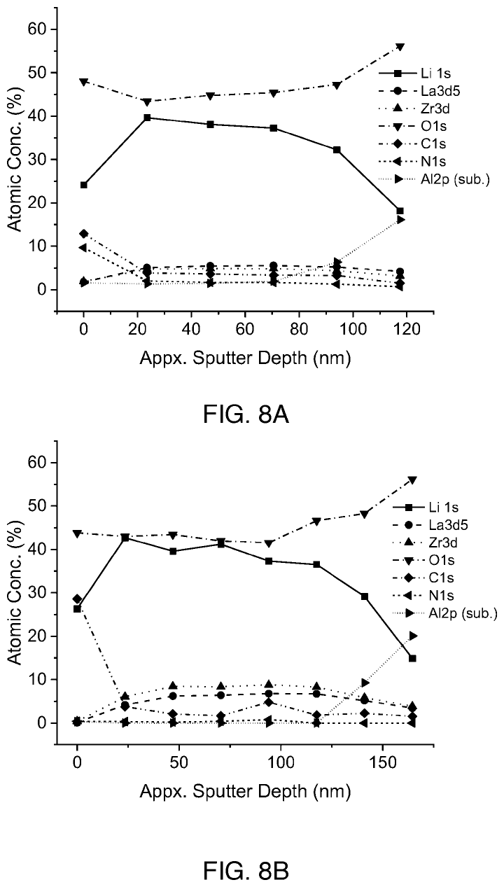

FIGS. 8A-B show XPS (X-ray photoelectron spectroscopy) depth profiling showing expected elemental composition of the layers and low Li loss. Here the two plots compare between plasma cured LLZO in FIG. 8A and argon atmosphere sintered LLZO in FIG. 8B.

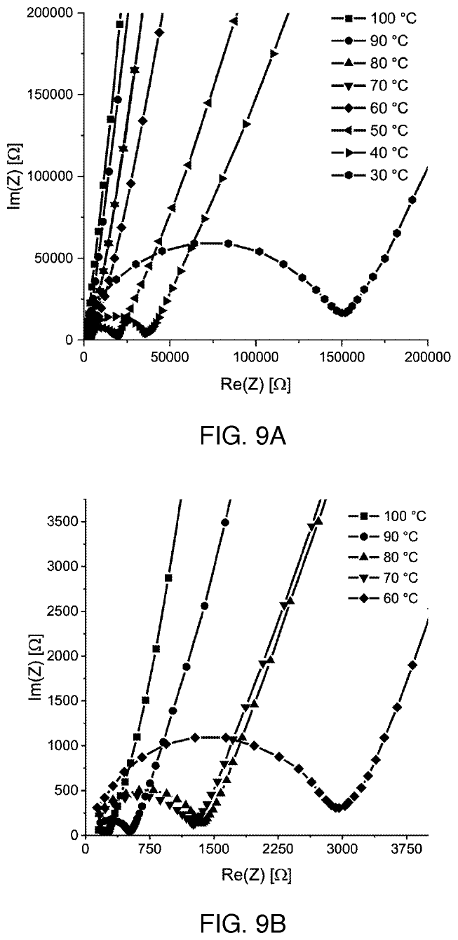

FIGS. 9A-B show in-plane electrochemical impedance spectroscopy from 30° C. to 100° C. of a plasma-cured LLZO layer. Here FIG. 9B has smaller x-axis and y-axis ranges in order to more clearly show the results near the origin on FIG. 9A.

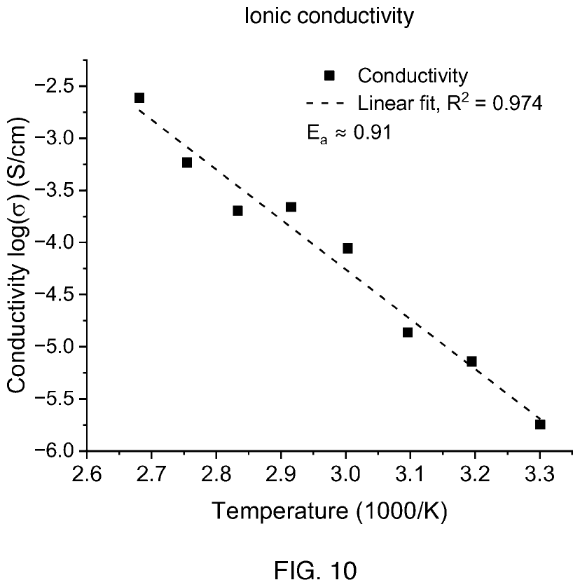

FIG. 10 is a Arrhenius plot showing the activation energy of Li conductivity through the plasma-cured LLZO electrolyte layer. We see a room temperature ionic conductivity well over 10⁻⁶ S/cm, which is among the highest conductivities for fully amorphous LLZO.

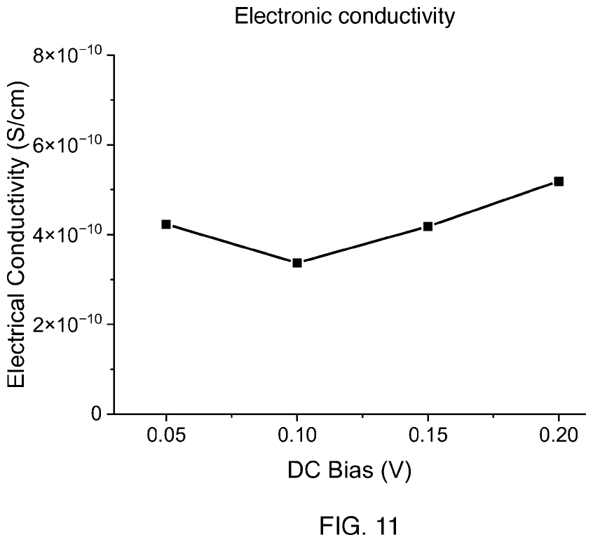

FIG. 11 shows measured electronic conductivity of the plasma-cured electrolyte layer. The electronic conductivity is seen to be low, which is desirable for an ionic conductor.

1. A method of forming a solid-state ionic conductor layer, the method comprising:
solution depositing one or more precursors on a substrate to provide deposited precursors, wherein the deposited precursors comprise at least one metal species;
plasma treating the deposited precursors by exposing the deposited precursors to a plasma discharge to form the solid-state ionic conductor layer, wherein one or more chemical reactions including oxidation of the at least one metal species are driven by the plasma discharge to form the solid-state ionic conductor layer from the deposited precursors.

2. The method of claim 1, wherein a thickness of the solid-state ionic conductor layer is in a range from 10 nm to 200 μm.

3. The method of claim 1, wherein the at least one metal species includes one or more species selected from the group consisting of: Li, Na, K, Al, Mg, Rb, La, Zr, and Ti.

4. The method of claim 1, wherein a formation speed of the solid-state ionic conductor layer is in a range from 0.1 mm/minute to 100 m/minute.

5. The method of claim 1, wherein the plasma discharge includes one of more species selected from the group consisting of: N, Ar, O, H, and radicals or ions thereof.

6. The method of claim 1, wherein a temperature of the plasma discharge is between 100° C. and 900° C.

7. The method of claim 1, further comprising drying the deposited precursors after the solution depositing and before the plasma treating.

8. The method of claim 1, wherein the plasma discharge is into a gas shroud providing at least local control of relative humidity.

9. The method of claim 8, wherein the gas shroud provides a relative humidity of 5% or less and a controlled oxygen concentration between 0 and 25%.

10. The method of claim 8, wherein the gas shroud performs a condensation and densification function for the deposited precursors at a temperature in a range from 50° C. to 300° C.

11. The method of claim 1, wherein the solution depositing the precursors is done by a method selected from the group consisting of: spray deposition, blade deposition and slot-die casting.

12. The method of claim 1, wherein the solid-state ionic conductor layer is an electrolyte layer for a solid-state battery.

13. The method of claim 1, wherein an ionic conductivity of the solid-state ionic conductor layer is 10⁻⁹ S/cm or more.

14. The method of claim 1, wherein an electronic conductivity of the solid-state ionic conductor layer is 10⁻⁹ S/cm or less.

15. The method of claim 1, wherein the plasma discharge is an open-air plasma discharge.
